(19) United States
(12) Patent Application Publication
(10) Pub. No.: US 2008/0003978 A1
(43) Pub. Date: Jan. 3, 2008

(54) Method, system, and apparatus for improved bluetooth security during the pairing process

(76) Inventors: Uttam K. Sengupta, Portland, OR (US); Shreekant Thakkar, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/479,000

(22) Filed: Jun. 29, 2006

(51) Int. Cl. H04M 3/16

(52) U.S. Cl. 455/410

(57) ABSTRACT

In one embodiment, a method is provided. The method of this embodiment provides setting a first wireless device's transmit power level to a low power level; pairing the first wireless device with a second wireless device; and setting the first wireless device's transmit power level to a higher power level.

### FIELD

Embodiments of the present invention relate to secure wireless communications. More particularly, various embodiments relate to security of Bluetooth devices during the Bluetooth pairing process.

### BACKGROUND

Bluetooth devices may be vulnerable to eavesdropping and/or Personal Identification Number (PIN) cracking during the Bluetooth initial pairing process, even if Bluetooth security is enabled on the device.

During the Bluetooth pairing process, two Bluetooth devices generate a shared secret that is used for future communication between the two devices. If the shared secret, or key, is obtained by an attacking device, an attacker may monitor all data sent by the compromised device, or may be able to hijack the compromised device for its own use.

Bluetooth devices that have high transmit power levels, such as class 1 or class 2 Bluetooth devices, have transmit ranges of up to 10 meters for a class 2 device and up to 100 meters for a class 1 device. Thus, a hostile device may overhear the pairing process even though it is located a considerable distance from the pairing devices. A user who is pairing two Bluetooth devices may be unaware of a hostile device within range in environments such as airports or airplanes, hotels, office buildings, apartment buildings, shopping centers or other similar environments.

### BRIEF DESCRIPTION OF THE DRAWINGS

A better understanding of embodiments of the present invention can be obtained from the following detailed description in conjunction with the following drawings, in which:

FIG. 1 is diagram illustrating Bluetooth device pairing according to some embodiments.

FIG. 2 is a flow diagram illustrating Bluetooth device pairing according to some embodiments.

FIG. 3 is an illustration of a Bluetooth device according to some embodiments.

### DETAILED DESCRIPTION

In the following description, for purposes of explanation, numerous details are set forth in order to provide a thorough understanding of embodiments of the present invention. However, it will be apparent to one skilled in the art that these specific details are not required in order to practice the present invention as hereinafter claimed.

Embodiments of the present invention concern secure pairing of Bluetooth wireless devices. Bluetooth requirements and protocols are described in “Specification of the Bluetooth System: Core, Version 2.0+Enhanced Data Rate (EDR),” published Nov. 4, 2004 by the Bluetooth Special Interest Group, Inc. Various embodiments described herein provide techniques to enable devices within a predetermined range to commence the Bluetooth pairing process. In some embodiments, devices that are out of range may not pair or eavesdrop on the pairing process.

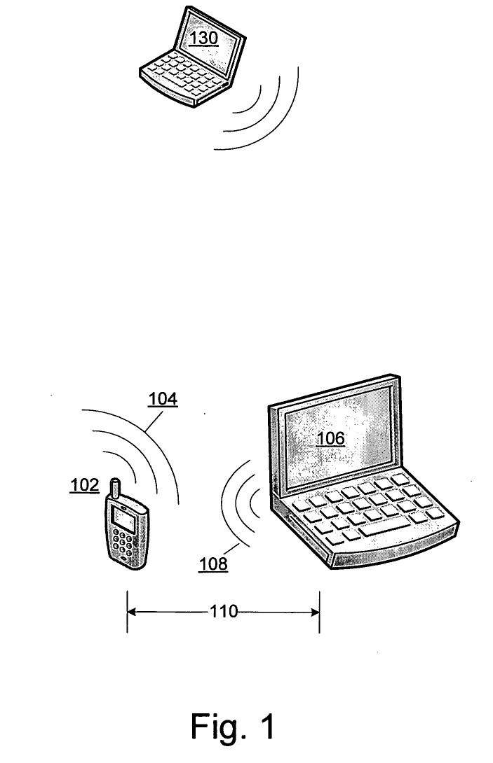

FIG. 1 is a diagram that illustrates the Bluetooth pairing process according to various embodiments. Devices 102 and 106 may transmit and receive signals 104 and 108 to pair with each other under the Bluetooth wireless protocol. Devices 102 and 106 may be any Bluetooth enabled device, including, but not limited to a cellular telephone, a personal digital assistant (PDA), a notebook computer, or a computing or communication accessory, for example.

During a first time Bluetooth pairing process, two devices (e.g. devices 102 and 106) may discover each other, and a personal identification number (PIN) may be entered by a user on one or both of the devices. The PIN may then be used to derive additional encryption keys. After two devices have been initially paired using the PIN authentication process, subsequent pairing may occur automatically whenever the devices are within each other's range and discover each other as known devices.

Devices 102 and 106 have a transmit power that is dependent on the power class of the device. As defined in the Bluetooth specification, Bluetooth devices may be classified into one or more of three power classes: class 1, having a maximum output/transmit power of 100 mW and an approximate range of 100 meters; class 2, having a maximum output/transmit power of 2.5 mW and an approximate range of 10 meters; and class 3, having a maximum output/transmit power of 1 mW and an approximate maximum range of 1 meter. In some embodiments, devices 102 and 106 may discover each other and pair only if each device's transmit power conforms to Bluetooth power class 3, e.g., a maximum transmit power of 1 mW and an approximate transmit range of less than 1 meter.

In the future, additional device classes having higher or lower maximum transmit powers may be included in the Bluetooth specification. For example, a new device class (e.g., class 4) may be created for devices having a maximum transmit power and range of less than that specified for class 3 devices.

In various embodiments, a class 3 Bluetooth device may be designed to have a transmit power level that is less than the specified 1 mW maximum power. In this case, the device conforms to class 3 device requirements, because the device's maximum transmit power does not exceed the maximum power specified by the Bluetooth specification. In other embodiments, A class 3 device's transmission range may be limited to a distance of less than 1 meter if the device's transmit power is reduced accordingly. In some embodiments, a class 3 device may be designed to have a transmit power that enables a predetermined maximum transmission range 110, for example, a range of approximately 10 cm or less.

Thus, in some embodiments, in order for devices 102 and 106 to pair, they should be within a predetermined distance of one another, where the predetermined distance is less than or equal to the predetermined maximum transmission range of each device. In some embodiments, this predetermined distance may be approximately equivalent to the class 3 range of the devices, as illustrated by distance 110. As stated above, the class 3 range is dependent upon the transmit power of the device, and in some cases may be significantly less than 1 meter.

Subsequent to pairing, one or both devices may operate at a higher power level, such as a class 1 or class 2 power level, thus allowing communications between the devices to occur at greater distances than predetermined distance 110. However, during the pairing process, the devices transmit at a low power level (e.g., a class 3 power level or a sub-class 3 power level), and thus should be located within a predetermined distance of each other (e.g., within 10 cm) during the pairing process.

Limiting the transmit power during the pairing process in turn limits the transmit range of the pairing devices. Thus, in order for a hostile device 130 to eavesdrop on the pairing process, it should also be within the transmit range 110 of the devices. This greatly reduces the chances that a hostile device 130 will be able to eavesdrop on the pairing process without being detected, because an eavesdropping device is much more likely to be visually detected by the user of the pairing devices if the hostile device is within a short distance, for example, approximately 10 cm, of the pairing devices.

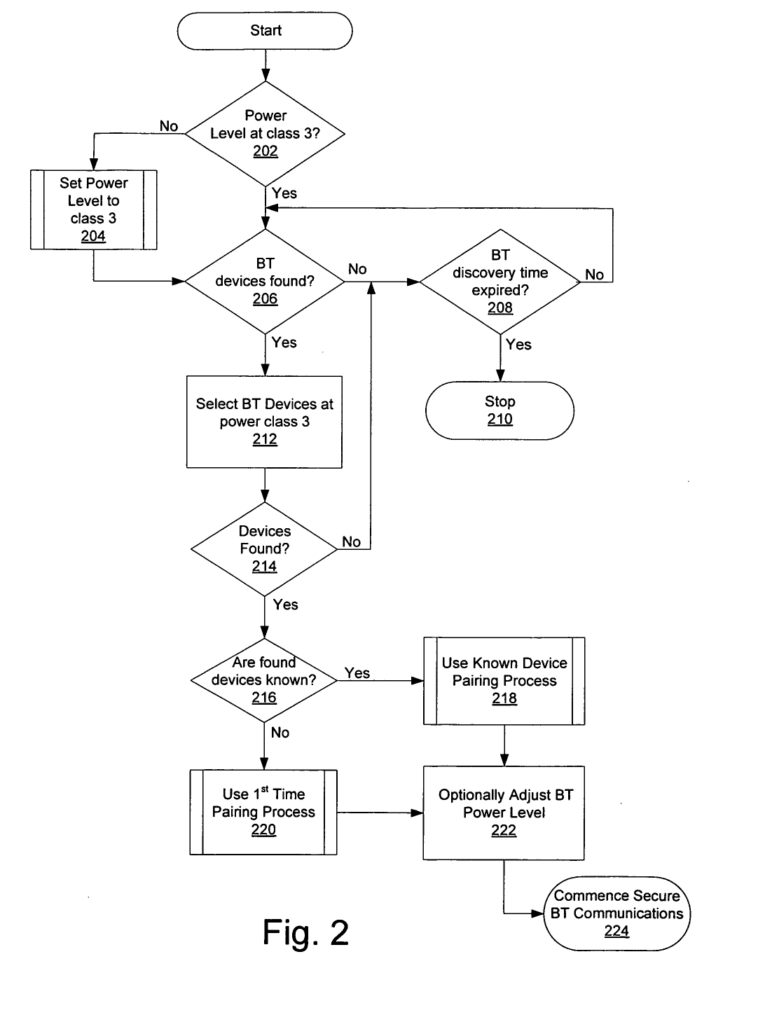

FIG. 2 is a flow diagram illustrating a technique for pairing Bluetooth devices according to some embodiments. The technique illustrated in FIG. 2 may be initiated in several different ways, at various predetermined times. First, this procedure may be initiated by a Bluetooth device when the device is powered on. The procedure may also be initiated by a device when the device's Bluetooth wireless interface is powered on or enabled. It may also be initiated upon discovery of another Bluetooth device. The procedure may be initiated at other times as well, prior to device pairing.

According to some embodiments, prior to pairing with another device, a Bluetooth device's transmit power level should be set to a low power level. A low power level may be one which conforms to the Bluetooth power class 3 specifications, including the maximum transmit power requirement. In some embodiments, the transmit power may be at lower levels than the maximum class 3 specification. For example, the device may be designed to have a class 3 transmit power that enables a transmission range of a predetermined distance that is less than 1 meter, and in some embodiments is significantly less than 1 meter. The device may determine whether or not it conforms to the class 3 specifications (block 202). In some embodiments, the device class and corresponding transmit power level may be determined using hardware, software, firmware, or a combination of these elements. For example, in some embodiments, a device's class may be specified by a register setting.

If the device's power level does not conform to the class 3 specification (e.g. having a transmit power of less than 1 mW), the power level may then be set to a class 3 conforming power level (block 204). In various embodiments, setting the power level to a class 3 power level may be achieved using hardware, software, firmware, or a combination of these elements.

When the device's power level is at a class 3 power level, it may discover other Bluetooth devices for pairing (block 206). If no other devices are immediately found, the device may continue to attempt to discover other devices until the Bluetooth discovery time has expired (block 208). When the discovery time has expired, the device may turn off its Bluetooth interface, or may power itself off (block 210).

If other Bluetooth devices are discovered, the device may select only those Bluetooth devices that have a class 3 transmit power for pairing (block 212). If no such devices are found, the device may continue to attempt to discover other devices until the Bluetooth discovery time has expired (block 208).

If class 3 devices are found, the device may pair with the found device, thus establishing a secure Bluetooth connection between the two devices. The pairing process will depend on whether the found device is a known device (e.g., a device with which pairing has previously occurred) or an unknown device (e.g., a device with which pairing has not previously occurred) (block 216). If the found device is a known device, the known device pairing process may be used (block 218), and pairing may occur automatically upon discovery. Discovery may occur if the devices are within range of one another. If the found device is an unknown device, the first time pairing process may be used (block 220). During a first time Bluetooth pairing process, a personal identification number (PIN) may be entered by a user on one or both of the pairing devices. The PIN is then used to derive additional encryption keys.

At a predetermined time, such as after pairing has occurred (218, 220), the device may optionally increase its transmit power level to a higher power level, such as a class 1 or class 2 compliant power level. When pairing has completed and the device is at an appropriate power level, Bluetooth data communications may commence over a wireless Bluetooth communications link (block 224). During data communications, each device may transmit and receive data over the Bluetooth link.

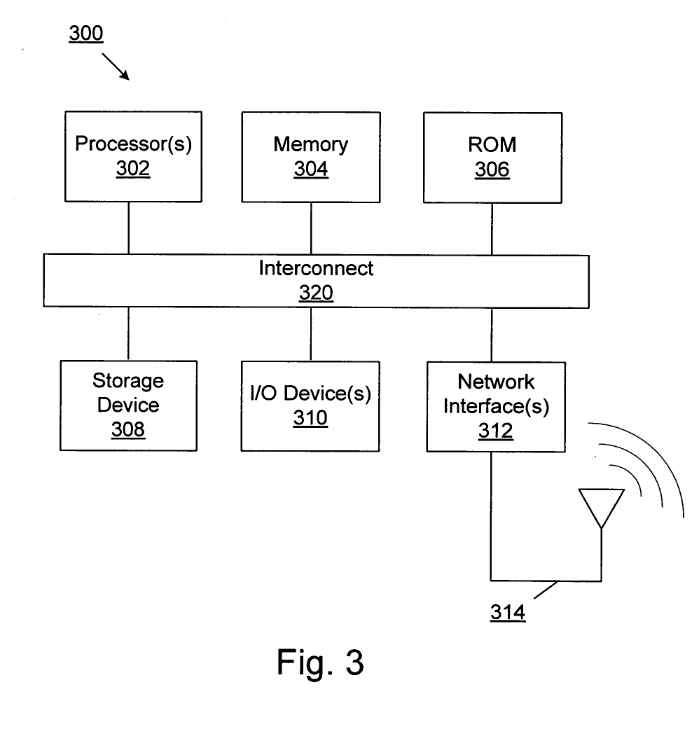

In various embodiments, the technique of FIG. 2 may be implemented as sequences of instructions executed by one or more electronic systems. The instructions may be stored by the electronic device or the instructions may be received by the electronic device (e.g., via a network connection). FIG. 3 is a block diagram of one embodiment of such an electronic system. The electronic system illustrated in FIG. 3 is intended to represent a range of electronic systems, for example, computer systems, PDAs, cellular telephones, etc. Alternative systems, whether electronic or non-electronic, may include more, fewer and/or different components.

Electronic system 300 may include interconnect 320 or other communication device to communicate information, and processor 302 may be coupled to interconnect 320 to process information. While electronic system 300 is illustrated with a single processor, electronic system 300 may include multiple processors and/or co-processors, or one or more processors having multiple cores. Electronic system 300 may further include random access memory (RAM) or other dynamic storage device 304 (referred to as memory), coupled to interconnect 320 to store information and instructions to be executed by processor 302. Memory 304 also may be used to store temporary variables or other intermediate information during execution of instructions by processor 302.

Electronic system 300 may also include read only memory (ROM) and/or other static storage device 306 coupled to interconnect 320 to store static information and instructions for processor 302. Data storage device 308 may be coupled to interconnect 320 to store information and instructions. Data storage device 308 such as a magnetic disk or optical disc and corresponding drive may be coupled to electronic system 300.

Electronic system 300 may also be coupled via an interconnect 320 to one or more input/output (I/O) devices 310. In some embodiments, I/O devices coupled to the system may include or more of a display device, such as a cathode ray tube (CRT) or liquid crystal display (LCD), an alphanumeric input device, such as a keyboard, and/or a cursor control device, such as a mouse, a trackball, or cursor direction keys.

Electronic system 300 further may include one or more network interface(s) 312 to provide access to a network, such as a local area network. Network interface(s) 312 may include, for example, a wireless network interface having antenna 314, which may represent one or more antenna(e). In one embodiment, network interface(s) 312 may provide access to a local area network, for example, by conforming to IEEE 802.11b and/or IEEE 802.11 g standards, and/or the wireless network interface may provide access to a personal area network, for example, by conforming to Bluetooth standards. In addition to, or instead of, communication via wireless LAN standards, network interface(s) 312 may provide wireless communications using, for example, Time Division, Multiple Access (TDMA) protocols, Global System for Mobile Communications (GSM) protocols, Code Division, Multiple Access (CDMA) protocols, and/or any other type of wireless communications protocol.

Instructions may be provided to memory from a storage device, such as magnetic disk, a read-only memory (ROM) integrated circuit, CD-ROM, DVD, via a remote connection (e.g., over a network via network interface 530) that may be either wired or wireless providing access to one or more electronically-accessible media, etc. In alternative embodiments, hard-wired circuitry may be used in place of or in combination with software instructions. Thus, execution of sequences of instructions is not limited to any specific combination of hardware circuitry and software instructions.

An electronically accessible medium includes any mechanism that provides (i.e., stores and/or transmits) content (e.g., computer executable instructions) in a form readable by an electronic device (e.g., a computer, a personal digital assistant, a cellular telephone). For example, a machine-accessible medium includes read only memory (ROM); random access memory (RAM); magnetic disk storage media; optical storage media; flash memory devices; electrical, optical, acoustical or other form of propagated signals (e.g., carrier waves, infrared signals, digital signals); etc.

Thus, a method, apparatus, and system for secure Bluetooth device pairing are disclosed. In the above description, numerous specific details are set forth. However, it is understood that embodiments may be practiced without these specific details. In other instances, well-known circuits, structures, and techniques have not been shown in detail in order not to obscure the understanding of this description. Embodiments have been described with reference to specific exemplary embodiments thereof. Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment. It will, however, be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

We claim:

1. A method comprising:
setting a first wireless device's transmit power level to a low power level;
pairing the first wireless device with a second wireless device; and
setting the first wireless device's transmit power level to a higher power level.

2. The method of claim 1, wherein the first wireless device and the second wireless device are devices conforming to the Bluetooth standard.

3. The method of claim 2, wherein setting the first wireless device's transmit power level to a low power level comprises setting the first wireless device's transmit power level to class 3.

4. The method of claim 3, wherein pairing the first wireless device with the second wireless device comprises placing the first wireless device and the second wireless device within a predetermined distance of one another.

5. The method of claim 4, wherein pairing the first wireless device with the second wireless device further comprises entering a personal identification number (PIN) on the first wireless device.

6. The method of claim 4, wherein the predetermined distance is less than 1 meter.

7. The method of claim 4, wherein the predetermined distance is less than 10 centimeters.

8. The method of claim 3, wherein setting the first wireless device's transmit power level to a higher power level comprises setting the first wireless device's transmit level to class 2.

9. The method of claim 2, wherein setting a first wireless device's transmit power level to a low power level occurs when the first wireless device is powered on.

10. The method of claim 2, wherein setting a first wireless device's transmit power level to a low power level occurs when a Bluetooth wireless interface is enabled on the first wireless device.

11. The method of claim 1, further comprising transmitting data from the first wireless device to the second wireless device over a Bluetooth communication link and receiving data from the second wireless device at the first wireless device over the Bluetooth communication link.

12. The method of claim 2, wherein the first wireless device is a cellular telephone.

13. The method of claim 2, wherein the first wireless device is a personal digital assistant (PDA).

14. An apparatus comprising:
a Bluetooth wireless interface, the Bluetooth wireless interface having a transmit power level; and
logic coupled to the Bluetooth wireless interface, the logic to set the transmit power level to a low power level at a first predetermined time and to set the transmit power level to a higher power level at a second predetermined time.

15. The apparatus of claim 14, wherein the first predetermined time is at power on of the apparatus.

16. The apparatus of claim 14, wherein the first predetermined time is at power on of the Bluetooth wireless interface.

17. The apparatus of claim 14, wherein the second predetermined time is after the apparatus has paired with a Bluetooth enabled device.

18. An article comprising a computer-readable medium having stored thereon instructions that, when executed, cause one or more processors to:
set a transmit power level to a low power level;
establish a connection with a wireless device; and
set the transmit power level to a higher power level after establishing the connection with the wireless device.

19. The article of claim 18, wherein the low power level conforms to a Bluetooth class 3 power level.

20. The article of claim 18, wherein the higher power level conforms to a Bluetooth class 2 power level.

21. The article of claim 18, wherein the wireless device conforms to a Bluetooth standard.

22. The article of claim 18, wherein the instructions, when executed, cause one or more processors to transmit data to the wireless device.

23. A system comprising:
a microprocessor;
an interconnect coupled to the microprocessor;
a Bluetooth wireless interface coupled to the interconnect, the Bluetooth wireless interface having a transmit power level;
logic coupled to the Bluetooth wireless interface, the logic to set the transmit power level to a low power level at a first predetermined time and to set the transmit power level to a higher power level at a second predetermined time; and
an antenna coupled to the Bluetooth wireless interface.

24. The system of claim 23, wherein the first predetermined time is at power on of the system.

25. The system of claim 23, wherein the first predetermined time is at power on of the Bluetooth wireless interface.

26. The system of claim 23, wherein the second predetermined time is after the apparatus has paired with a Bluetooth enabled device.
